(19) United States
(12) Patent Application Publication
(10) Pub. No.: US 2025/0007154 A1
(43) Pub. Date: Jan. 2, 2025

(54) ANTENNA SYSTEMS

(71) Applicant: SATRAKA LIMITED, Didcot (GB)

(72) Inventors: Sijiao SUN, Didcot (GB); Tao HUANG, Didcot (GB)

(73) Assignee: SATRAKA LIMITED, Didcot (GB)

(21) Appl. No.: 18/682,105

(22) PCT Filed: Aug. 8, 2022
(86) PCT No.: PCT/GB2022/052065

§ 371 Date: Feb. 7, 2024

(30) Foreign Application Priority Data
Aug. 7, 2021 (GB) 2111416.0
Aug. 26, 2021 (GB) 2112255.1

(51) Int. Cl. H01Q 3/18; H01Q 1/12; H01Q 1/24; H01Q 3/04; H01Q 3/24; H01Q 15/02; H01Q 15/16; H01Q 19/10

(52) U.S. Cl. CPC H01Q 3/18; H01Q 1/125; H01Q 1/247; H01Q 3/04; H01Q 3/247; H01Q 15/02; H01Q 15/165; H01Q 19/102

(57) ABSTRACT

Antenna systems with beam tracking and scanning ability are described. The antenna systems include one or more reflectors and one or more feeds. The tracked or scanned beam(s) are produced by moving the feed(s) while the reflector(s) is kept static. This greatly reduces the complexity of the antenna beam tracking and scanning mechanism, while providing the highest possible antenna efficiency and gain in a wide angular range. Multiple beams and/or switched beams can also be achieved using multiple feeds and/or switches.

### TECHNICAL FIELD

The present disclosure relates to antenna systems.

### BACKGROUND

High data rate telecommunications are required in a variety of applications, such as in the non-geostationary satellite orbit (NGSO) satellite-based broadband internet services and terrestrial millimetre wave 5G/6G networks. A high data rate telecom system needs high gain antennas, whose beamwidth is narrow (beamwidth varies inversely with the increase of the gain), thus the coverage range is small. To overcome this problem, the telecom system can use multiple antennas, or a single antenna with multiple-beams, a shaped-beam or a tracking-beam. In practice, a single antenna with a tracking-beam is mostly used, to minimise costs and the space required for the antenna system.

Taking the beam-tracking or beam-scanning antenna as an example, beam-tracking is usually achieved by rotating the entire antenna system mechanically. Such antennas are known as mechanical steering antennas (MSAs). This is the case often seen in the radar and satcom on the move (STOM) market. Phase array antennas (PAAS), also referred to as flat panel antennas (FPAs) or electronic steering antennas (ESAs), are popular in radar applications too, where multiple beams are made possible electrically by a complex phase steering network.

There are challenges, however, in deploying either of the technologies described above to a mass consumer market. The challenges arise in two aspects-cost and technical performance.

### i) Cost

The cost associated with MSAs is mainly attributed to the rotation and control mechanism of the antenna, whose design must be robust and reliable to withstand the mass and stress of the entire antenna system for continuous 24/7 operations in all weather conditions. This results in a bulky and sophisticated scanning and tracking mechanism and system, and ultimately increases the cost.

For many applications, such as tracking NGSO satellites, a beam handover is required from one satellite to another in each tracking cycle. This happens when the tracked satellite moves to the end of the service coverage, and the telecom link needs to be handed-over to the incoming satellite. A conventional MSA, driven by electrical motors and gears, is not able to change the beam direction fast enough for a seamless handover. Hence, two MSA systems are required at each ground user terminal. This doubles the cost and space required for each user terminal.

For ESAs, the cost is significantly increased for the generation and control of radio frequency (RF) signals' phase and magnitude, on each of the hundreds and thousands of array elements, in whatever ways or technologies it is implemented (e.g., using integrated circuit (IC) modules, liquid crystal display (LCD) technology, optical lens and meta surfaces). Hence ESAs are predominantly applicable and used for military applications (e.g., modern fighter jets) and in mobility (aeroplane) markets. The high cost is prohibitive for the mass consumer market.

### ii) Performance

The RF performance of the ESA/FPA, in terms of antenna efficiency, gain and radiation beam, degrades quickly with the increase of the beam tracking or scanning angles. This is due to the fact that the effective antenna surface area to the beam direction diminishes with the increase of the tracking or scanning angle. This is a fundamental performance issue associated with the ESA/FPA technology, regardless of what type of beam-tracking or steering method is used. Moreover, losses increase significantly from the array radiating element, which is typically of patch or slot type and built on a printed circuit board (PCB). Losses from the feed and phase network, e.g., in the IC module where the required phase and magnitude for each of the array elements is generated, is also very high. All of these result in a high power consumption, a very low antenna efficiency and degraded antenna beam.

Another fundamental technical performance challenge with ESA/FPA technology is the limited operating frequency bandwidth. This results in separate transmit (Tx) and receive (Rx) antenna arrays. Thus effectively two antennas are required for each terminal, like the MSA.

The RF performance of MSA systems can be good. However, the reliability of the rotation mechanism for the entire antenna (which may have a mass of several hundred kilograms), for continuous 24/7 operation and in all weather conditions is a matter of concern. A robust design can be used, and the mechanism can be constructed with high quality materials. However, this pushes the cost up and makes the antenna system heavy and bulky.

For these reasons, neither of the above mentioned technologies are viable solutions for the growing consumer market such as those in NGSO satellite-based and 5G/6G millimetre wave-based broadband markets. Even with significant investment in these technologies, particularly on ESA/FPA in recent years, little progress has been made on the provision of the low cost and high-performance beam-tracking antennas.

### SUMMARY OF INVENTION

The present application describes antenna systems which address the above challenges. Firstly, reflector type of antennas are used to offer high gain and efficiency, when the reflector is a toroidal type constant beams (no degradation) over the wide scanning range are achieved. Secondly, the systems operate by moving the feed system (which typically has a mass of a few kilograms) instead of the entire antenna (which typically has a mass of several hundreds of kilograms) to achieve the tracking or scanning beams. Thirdly, the systems use two or more feeds to produce scanning or multiple beams and fulfil beam handover requirements (e.g., in tracking NGSO satellites) on a single antenna.

The simplification of the beam tracking mechanism significantly reduces the complexity of antenna design, improves the reliability of the system, and ultimately reduces the cost. The cost can be further reduced by a modular approach in the reflector design, manufacturing, packaging, transportation and assembly. This is particularly true for the toroidal type reflectors, where the full reflector surface can be divided into multiple identical sub-panels.

The use of a feed horn in certain examples ensures that a wide frequency bandwidth can be achieved to cover both the Tx and Rx bands.

The antenna systems described herein can use tracking-beam(s), scanning-beam(s), multiple-beams or shaped-beam(s) to provide a wide angular range coverage to users or targets. The antenna systems described herein have a wide range of applications, including, but not exclusively limited to, applications such as tracking NGSO satellites in satellite-based broadband internet system, FWA in 5G/6G terrestrial network, radar drone detection or border control, HTS (high throughput satellite) multiple beams.

The antenna systems described herein offer high technical performance (e.g., high gain and efficiency, constant and/or multiple beams over wide angle range), low-cost, reliable beam-tracking and seamless beam-handover in just one structure.

According to a first aspect of the present invention, there is provided an antenna system comprising: a reflector comprising a first reflector portion having a curved shape defined with respect to a first reference point, and a second reflector portion having a curved shape defined with respect to a second reference point, the second reference point being different from the first reference point; a first feed arranged to illuminate the first reflector portion with a first beam; a second feed arranged to illuminate the second reflector portion with a second beam; one or more first actuators arranged to move the first feed; one or more second actuators arranged to move the second feed; and a controller configured to control the first actuator and the second actuator to move the first feed and the second feed so as to continuously track a moving target or continuously scan a number of targets.

The controller may be configured to control the first actuator to move the first feed from a first start position to a first end position so as to scan the first beam across the first reflector portion; and control the second actuator to move the second feed from a second start position to a second end position so as to scan the second beam across the second reflector portion.

The controller may be configured to control the first actuator to move the first feed from the first end position back to the first start position while the second feed is moving from the second start position to the second end position.

The controller may be configured to control the second actuator to move the second feed from the second end position to the second start position while the first feed is moving from the first start position to the first end position.

When the first feed is at the first end position and the second feed is at the second start position, the first beam and the second beam may be substantially coincident on the reflector.

The first reflector portion and the second reflector portion may be joined together at a joint line. The first and second reflector portions and the first and second feeds may be arranged such that, in use, a common beam is produced by each of the first and second reflector portions and the first and second feeds at the joint line, thereby allowing a beam handover from the first reflector portion to the second reflector portion at or near the joint line.

The one or more first actuators may comprise a first actuator arranged to adjust the azimuth of the first beam and the one or more second actuators may comprise a second actuator arranged to adjust the azimuth of the second beam.

The one or more first actuators may comprise a first actuator arranged to adjust the elevation of the first beam and the one or more second actuators may comprise a second actuator arranged to adjust the elevation of the second beam.

The antenna system may comprise a support mast arranged to support the first reflector portion and the second reflector portion.

The antenna system may comprise a first support mast arranged to support the first reflector portion and a second support mast arranged to support the second reflector portion.

The antenna system may comprise a first reflector portion actuator arranged to adjust the elevation of the first reflector portion to thereby adjust the elevation of the first beam and/or a second reflector portion actuator arranged to adjust the elevation of the second reflector portion to thereby adjust the elevation of the second beam.

The first reference point may represent the centre of a first imaginary torus and the first reflector portion may have a shape corresponding to a section of the first imaginary torus. The second reference point may represent the centre of a second imaginary torus and the second reflector portion may have a shape corresponding to a section of the second imaginary torus.

The first reference point may represent the focus of a first imaginary paraboloid and the first reflector portion may have a shape corresponding to a section of the first imaginary paraboloid. The second reference point may represent the focus of a second imaginary paraboloid and the second reflector portion may have a shape corresponding to a section of the second imaginary paraboloid.

The reflector may be a prime-focus type reflector or an offset type reflector.

The antenna system may comprise an RF transceiver connected to the first feed and the second feed.

The antenna system may comprise a first RF transceiver connected to the first feed and a second RF transceiver connected to the second feed.

The first reflector portion and the second reflector portion may each comprise a plurality of panels.

The shape of the second reflector portion may be a mirror reflection of the shape of the first reflector portion.

The antenna system may comprise one or more correction measures arranged to correct phase aberration in the reflector. The one or more correction measures may comprise one or more of the following: a lens disposed inside or in front of the first feed and/or the second feed; a transmit-array disposed in front of the feed, wherein the transmit-array is based on RF meta-material technology; and a reflect-array disposed on the torus surface, wherein the reflect-array comprises a meta-surface.

According to a second aspect of the present invention, there is provided an antenna system comprising: a toroidal reflector; a plurality of feeds arranged to illuminate the reflector, the feeds being arranged around a common axis; a motor configured to generate a rotary force to rotate the feeds about the axis; and a first controller configured to control the motors to rotate the feeds about the axis so as to continuously track a moving target or continuously scan a number of targets.

The antenna system may comprise a second controller; and an RF switch connected to the feeds. The second controller may be configured to activate the RF switch when an antenna beam handover from one of the feeds to another one of the feeds is required.

The antenna system may comprise an RF transceiver; and an RF rotary joint arranged to transfer an RF signal from the RF transceiver to the feeds or vice versa.

According to a third aspect of the present invention, there is provided an antenna system comprising: a toroidal reflector; and a plurality of feeds facing the reflector and arranged to illuminate the reflector simultaneously.

The antenna system may comprise one or more RF transceivers connected to the feeds.

Each of the RF transceivers may be connected to a respective feed or a group of feeds. The RF transceivers may be arranged to control the feeds to provide tracked beams or switched beams, or multiple beams simultaneously.

The antenna system may comprise a plurality of RF switches connected to the feeds. The RF switches may be arranged to perform beam-switching by selecting different feeds.

The antenna system may comprise an antenna beam-forming network configured to combine one or more of the feeds together to form a shaped beam.

The antenna system may comprise a computer-readable medium storing a beam-forming algorithm for beam-tracking using the feeds.

The feeds may be arranged at least partially around a common axis.

According to a fourth aspect of the present invention, there is provided an antenna system comprising: a ring-shaped toroidal reflector; and a moveable feed disposed inside the reflector, the feed being arranged to illuminate the reflector with a beam.

The antenna system may comprise a first motor disposed inside the reflector. The first motor may be arranged to rotate the feed around the central axis of the reflector so as to scan the beam around the entire reflector.

The antenna system may comprise a boom system disposed inside the reflector and arranged to support the feed. The boom system may comprise a second motor arranged to adjust the elevation of the feed to thereby adjust the elevation of the beam.

The antenna system may comprise a transceiver disposed inside the reflector and connected to the feed.

According to a fifth aspect of the present invention, there is provided an antenna system comprising a ring-shaped toroidal reflector; and a plurality of feeds disposed inside the reflector, each of the feeds being arranged to face the reflector and illuminate the reflector with a respective beam.

The antenna system may comprise a plurality of RF switches connected to the feeds; and a controller configured to control the RF switches so as to selectively activate a particular feed to illuminate a particular region of the reflector.

According to further aspects of the present invention, there is provided a user terminal or satellite comprising: a body; and an antenna system as described above. Part of the body may be disposed inside the reflector, and the feeds of the antenna system are disposed on the outside of the body to produce multiple spot beams on the Earth's surface in use.

The satellite may be a high throughput satellite.

### BRIEF DESCRIPTION OF THE DRAWINGS

The embodiments of the invention will be described, by way of examples, with reference to the drawings in which:

FIGS. 1(a), 1(b) and 1(c) show an example of a beam-tracking antenna system;

FIGS. 2(a) to 2(f) illustrate examples of the formation of sectorial and ring-type toroidal reflectors;

FIGS. 3(a) and 3(b) show examples of the antenna beams at −50°, −40°, −30°, −20°, 0° and +30° from a sectorial type toroidal reflector;

FIGS. 4(a), 4(b) and 4(c) illustrate an example of the formation of the reflector shown in FIG. 1;

FIGS. 5(a), 5(b), 5(c) and 5(d) show a variant of the beam-tracking antenna system shown in FIG. 1;

FIGS. 6(a), 6(b) and 6(c) show a variant of the beam-tracking antenna shown in FIG. 1;

FIGS. 7(a), 7(b) and 7(c) show a variant of the beam-tracking antenna shown in FIG. 1;

FIG. 8 shows a variant of the beam-tracking antenna shown FIG. 5;

FIGS. 9(a), 9(b) and 9(c) show a variant of the beam-tracking antenna shown in FIG. 1;

FIGS. 10(a), 10(b) and 10(c) show an example of a beam-tracking antenna system including multiple feed systems;

FIG. 11 shows a variant of the beam-tracking antenna;

FIG. 12 shows a variant of the beam-tracking antenna;

FIGS. 13(a) and 13(b) show an example of a beam-tracking antenna system including multiple feed systems;

FIGS. 14(a) and 14(b) show two exemplary antenna radiation patterns for beam-tracking, one by beam-switching and the other by beam-shaping;

FIG. 15 shows the structure of the reflector shown in FIG. 1;

FIGS. 16(a), 16(b), 16(c) and 16(d) show an example of a ring-type toroidal reflector;

FIGS. 17(a) and 17(b) show examples of the scanning beams from the antenna system shown in FIG. 16;

FIGS. 18(a), 18(b) and 18(c) illustrate how the beam-direction of the antenna system shown in FIG. 17 changes with the shape of the toroidal reflector;

FIGS. 19(a) to 19(f) illustrates how the beam-direction of the antenna system shown in FIG. 17 changes with the movement of the feed horn;

FIGS. 20(a) to 20(d) show examples of downward tilt beam(s) on a ring-type toroidal reflector with one feed and multiple feeds;

FIG. 21 shows an example of a satellite which includes an antenna system with a ring-type toroidal reflector; and

FIG. 22(a) shows examples of measures for alleviating or correcting phase aberration in a torus reflector, and FIG. 22(b) shows a graph which illustrates the effect of phase aberration in a torus reflector.

### DETAILED DESCRIPTION

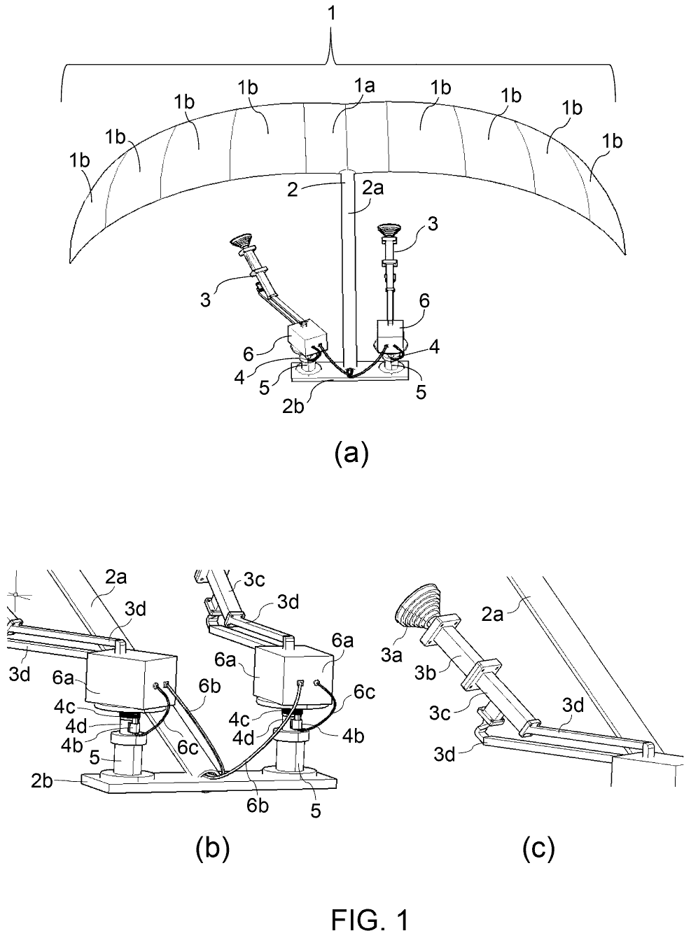

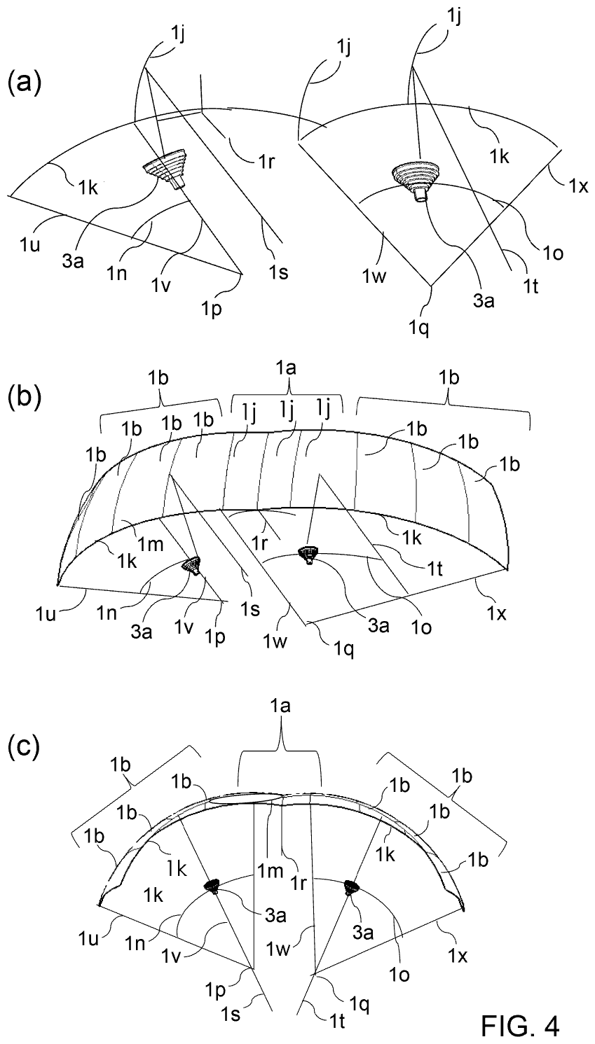

FIG. 1 shows an example of a beam-tracking antenna system including a shaped toroidal (or torus) reflector 1. The reflector 1 includes a first/left reflector portion and a second/right reflector portion which are joined together at a joint line. The reflector 1 is symmetric about the joint line. The structure of the reflector will be described in more detail below in relation to FIG. 4.

The antenna system also includes two feed systems 3 facing the reflector 1. The first feed system 3 illuminates the first reflector portion with a first beam, and the second feed system illuminates the second reflector portion with a second beam. In the present example, the feed systems 3 include feed horns. Each of the feed systems 3 is connected to a corresponding RF transceiver 6, which sits on a rotary joint 4 and is supported by a linear actuator 5. Each rotary system 4 is arranged to rotate the corresponding feed system 3 so as to scan the beam across the reflector portion. A boom support system 2 provides the mechanical structure to support feed system 3, rotary joint 4, actuator 5 and RF transceiver 6.

An example of the beam-tracking operation of the antenna system will now be described. The full beam tracking range, e.g., from −45° to +45°, is divided into two halves. The first half is from −45° to 0° and the second half is from 0° to +45°. The beam tracking is carried out by rotation of the feed horn 3a. It begins with Horn 1 (left-hand side feed horn) at −45° (at the left edge of the left reflector portion). Horn 1 scans from −45° towards 0° at the antenna centre while Horn 2 (right-hand side feed horn) is positioned at 0°. When Horn 1 reaches the centre, two 0° antenna beams are produced, one from each feed horn. Beam handover is performed at this point, i.e., the communication link (e.g., to a NGSO satellite) is handed over from one feed horn (Horn 1) to another (Horn 2), for the continuous beam-tracking thereafter. When Horn 2 is in action, Horn 1 is returned to its starting position (pointing to the left edge of the left-side reflector). This ensures a successful second beam handover from Horn 2 back to Horn 1 when Horn 2 reaches its end of the scan range at +45° (pointing to right edge of the right reflector portion). In NGSO satellite tracking, the second handover is associated with the link handover to an incoming satellite.

In the present antenna system, with two feed horns in one antenna, there is always one feed horn in action (active beam-tracking) and one feed horn on stand-by (positioned such that it is ready for taking over the link), other than at beam handover points where both feed horns are in action.

The above cycle repeats, providing a continuous beam-tracking and seamless handover to NGSO satellite constellation with a highly directive, consistent and high gain beam is realised in one antenna system.

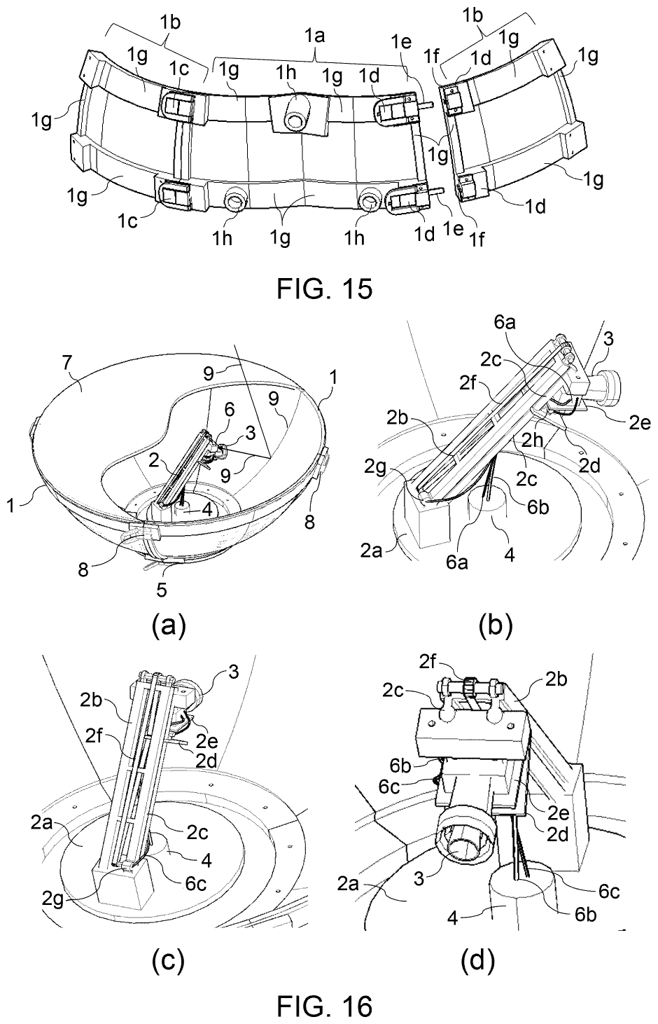

In FIG. 1 toroidal reflector 1 is composed of a central panel 1a and multiple identical panels 1b. This modular design has the advantages of reducing tooling and manufacturing cost, reducing the package volume, transportation and logistics cost and is scalable in product offering, e.g., increasing or reducing antenna size and beam-scan range by adding or reducing the number of panels 1b. Details of the modular approach design is given in FIG. 15, which ensures the antenna can be cost-effectively produced and easily assembled in the field.

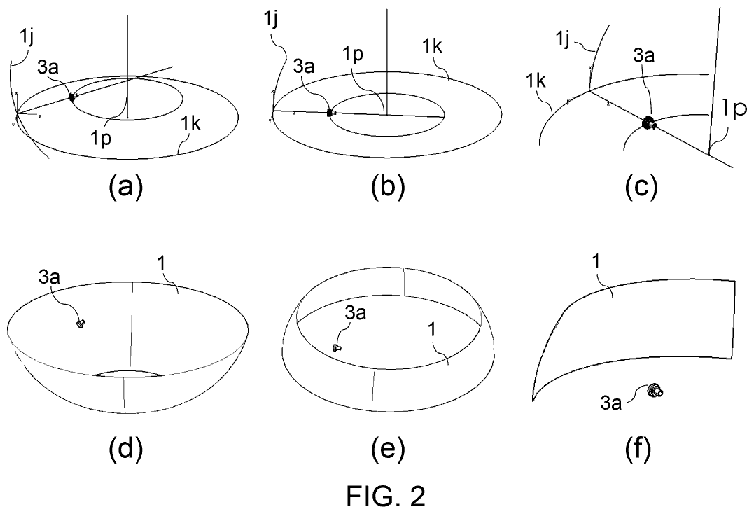

The toroidal reflector has the ability not only to offer the highest possible antenna gain and efficiency like a parabola reflector, but also to produce a constant beam regardless of the scan angles. This is attributed to the geometry of the torus reflector which is described in more detail in FIG. 2. The reflector surface can be made of, for example, pressed sheet-metal, moulded plastic with surface metallisation, or carbon-composite.

The boom support system 2 includes boom 2a, beaver-tail plate 2b and other necessary parts (e.g., fixing parts such as screws and bolts) to the reflector 1, feed system 3, rotary joint 4, actuator 5 and RF transceiver 6.

Although in the present example feed systems 3 includes horn type 3a feeds, other types of feeds can be used, such as patch or dipole antennas. The feed systems 3 further include polarizer 3b, orthogonal mode transducer (OMT) 3c, feed waveguide or transmission line 3d and associated components such as adaptors, diplexers and filters etc., The feed systems 3 define antenna operation frequencies, polarizations and impedance matching. The feed horn can be of a single band, multi-band or wide band type. The feed horn 3a can have a circular, rectangular or elliptical aperture, which is designed to provide an adequate illumination or reception of the RF power onto or from the reflector 1.

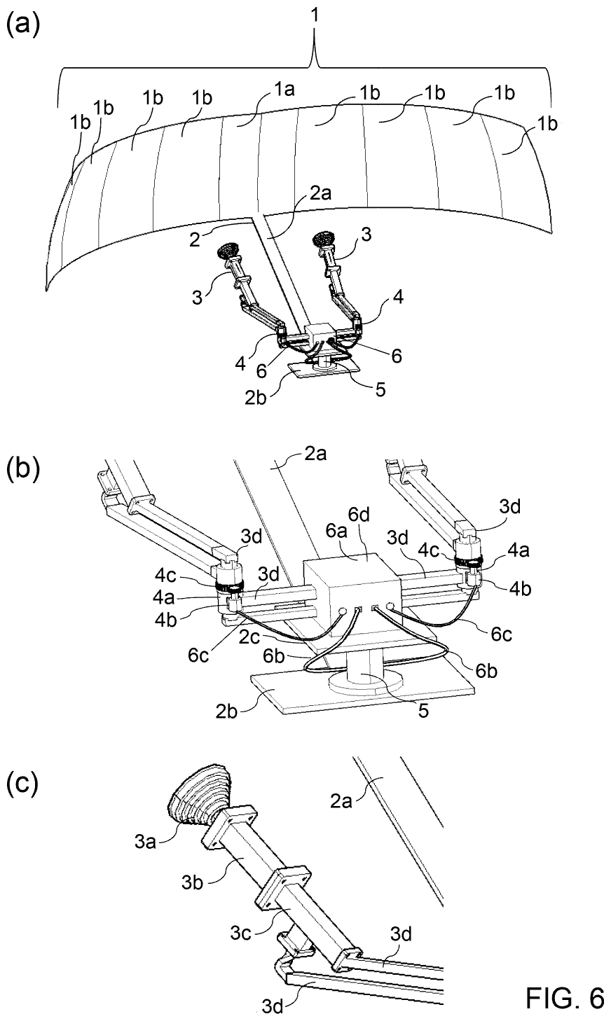

Rotary joints 4 enable the feed systems 3 to rotate so as to perform the antenna beam-scan. The rotary joints 4 can be a purely mechanical bearing 4d, or an RF (contact or contactless) rotary joint 4a (as shown in FIG. 6(b)). The rotation is controlled by the motor 4b and gear 4c.

The linear actuators 5 provide the ability to adjust the beam direction in the orthogonal plane (often referred as the elevation plane) to the beam-tracking plane (often referred as the azimuth plane). This mechanism is important to ensure the maximum beam is aimed at the user or target at all times, such as in NGSO satellite tracking to adjust the elevation angles (often referred to as “look up angles”) depending on the terminal location on Earth.

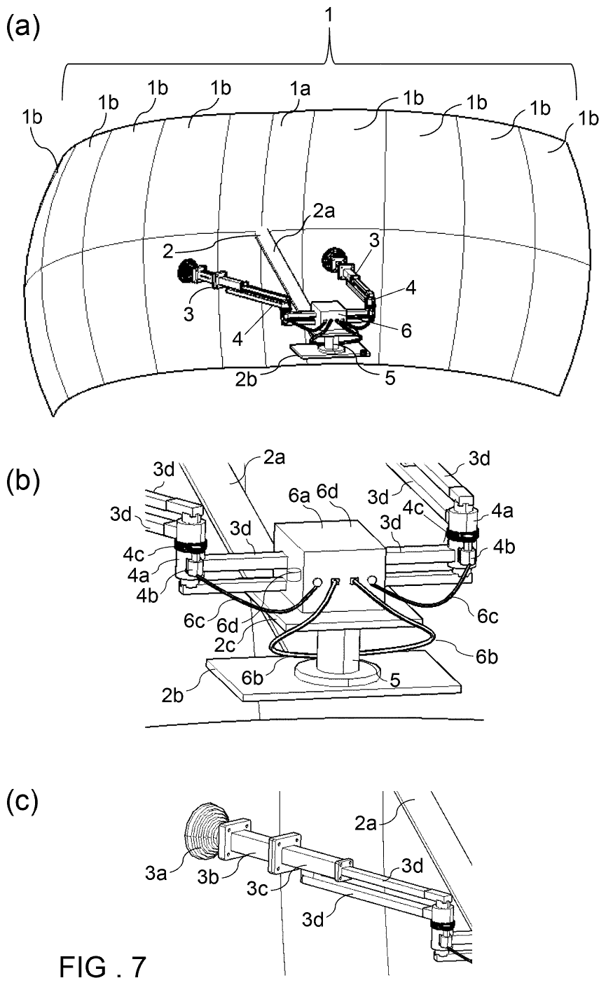

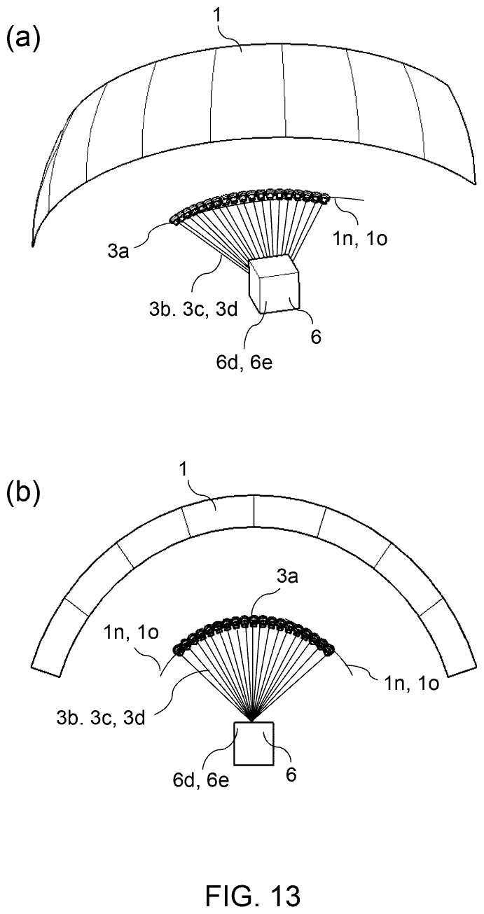

Each transceiver 6 includes an RF transmitter and receiver 6a, associated RF coaxial cable 6b, control wires 6c to motor 4b and actuator 5, RF switches 6d (also shown in FIG. 6, FIG. 7 and FIG. 13) and an RF beam former or combiner 6e (shown in FIG. 13).

The formation of a toroidal reflector, is illustrated in FIGS. 2(a) to 2(f). Generally, a toroidal surface is formed by sweeping a generating curve, typically a parabolic curve, along a defined axis. In FIG. 2, various parabolic generating curves 1j are used. The torus reflector 1 is formed by sweeping a parabolic curve 1j along a circle track 1k, which is centred at reference point 1p. This results in a circular surface horizontally (i.e., in the azimuth plane) and a parabola surface vertically (i.e., in the elevation plane), thus at any scan angle horizontally, the portion of the reflector surface to the feed 3a is the same, as is the antenna beam.

In FIG. 2(b), the sweeping is completed over 360° on a prime-focus, vertically-tilted parabolic curve shown in FIG. 2(a), producing a dish-type reflector surface. A ring-type toroidal surface is generated with an offset parabolic generating curve, as shown in FIGS. 2(c) and 2(d). When the sweeping angular range is limited (FIG. 2(e)), e.g., at +/−45°, a sectorial-type toroidal surface is produced, as shown in FIG. 2(f).

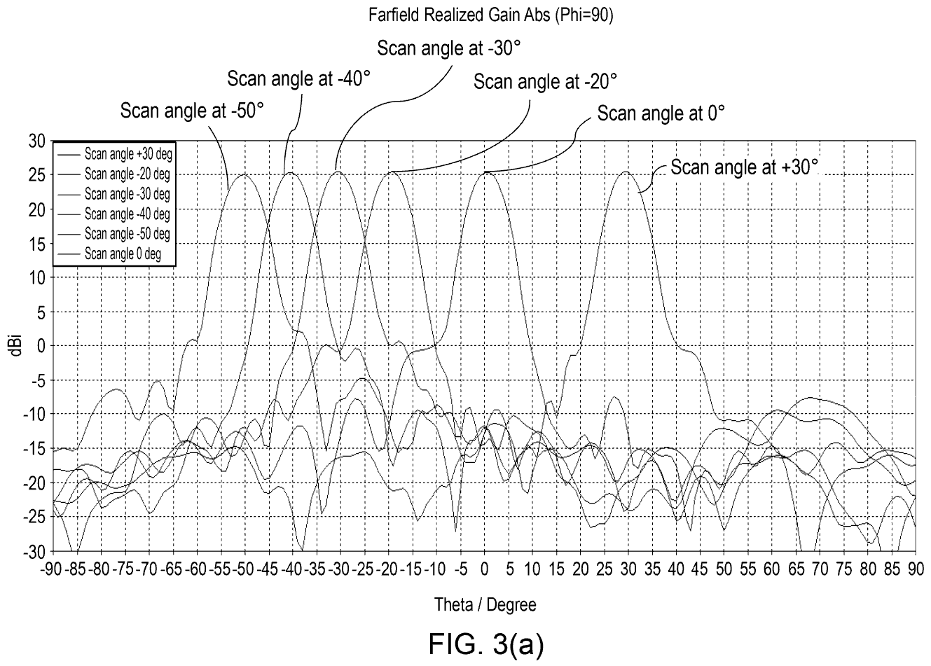

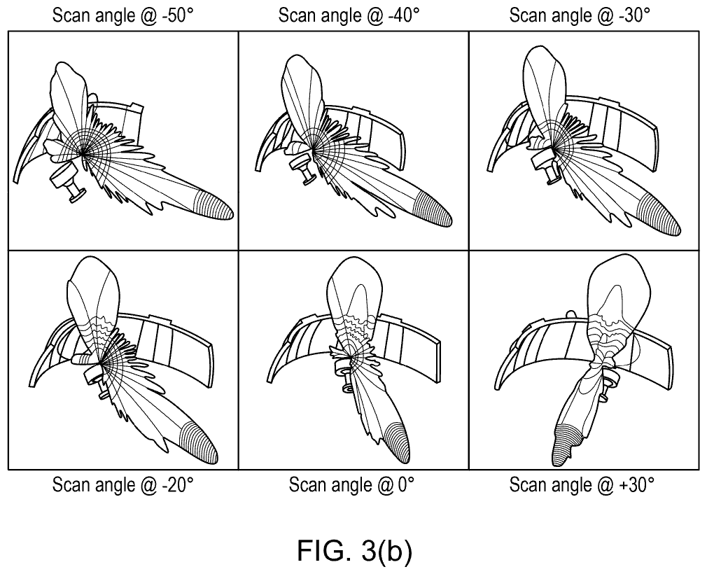

FIGS. 3(a) and 3(b) show exemplary beam patterns ranging from −50° to +30° of the beam-tracking antenna shown in FIG. 2(f). These beam patterns are simulated at 20 GHz frequency from an antenna with a focal length of 100 mm and height of 100 mm. A 25.2 dBi gain is achieved which translates into an efficiency of 75%. This is a very high antenna efficiency which is only achievable by reflector type antennas at this frequency. FIG. 3(a) is a 2-D cut of the beams in the scan plane, while FIG. 3(b) shows the corresponding 3-D beams. As shown, all beams are constant and identical (no degradations at all), regardless of the scan angles. This is an advantage of the torus reflector over a parabolic reflector, and even more over the phase array antennas where the beam and gain deteriorate rapidly with the increase of the scan angle.

The formation of the antenna shown in FIG. 1 is illustrated in FIGS. 4(a) to 4(c). The torus reflector 1 is formed by sweeping a parabolic curve 1j along a circle track 1k, which is centred at a first reference point 1p or a second reference point 1q. As an example, an offset parabola 1j is used in FIG. 4 for the formation of both the left reflector portion and the right reflector portion. The left-hand feed horn 3a is at 0° and produces a beam 1s along the antenna boresight 1r. The right-hand side feed horn 3a is positioned at 20°, which gives a beam 1t directed at +20°. The beam scan track and range for the left-hand feed horn is defined by 1n, ranging from a start point at 1u (e.g., at)−50° and a finish point at 1v (e.g., at) 0°. For the right-hand side feed the scan track and range is 10, which is formed by the start line 1w (e.g., at) 0° and finish line 1x (e.g., at)+50°. In the modular approach design, most of the torus surface is made by identical panels 1b. The central panel 1a is a result of joining the left-hand and right-hand sides of the torus surface together.

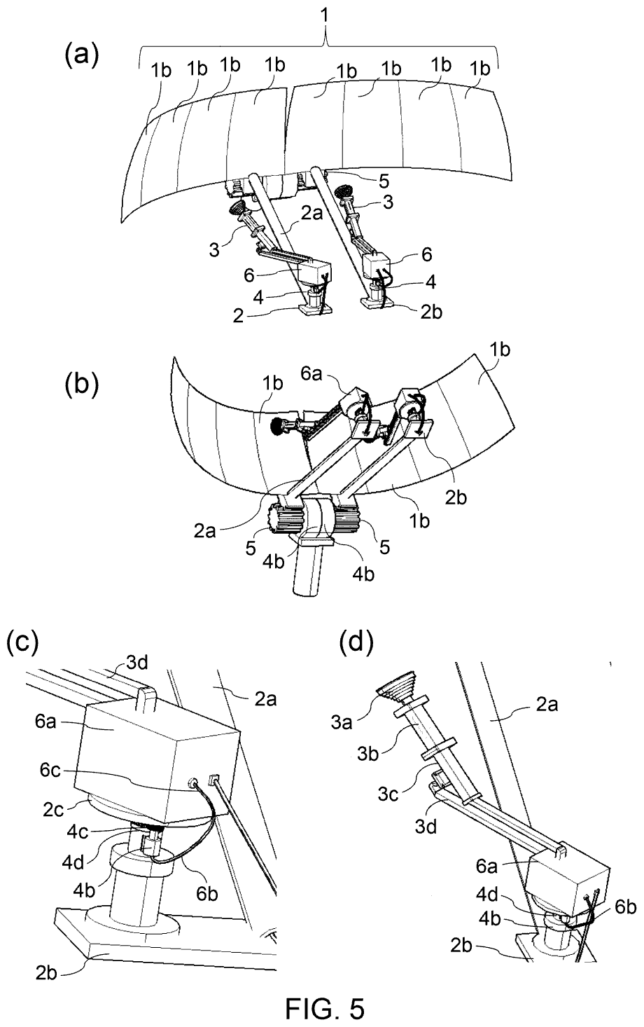

FIGS. 5(a) to (d) show an antenna system where each portion of the torus reflector is supported by its own actuator, motor and gear mechanism 5. This allows each portion of the reflector to operate independently with the ability to perform beam-tracking in any direction (in both the azimuth and elevation planes). At 0° beam handover, however, the two halves of the reflectors are lined up to ensure the same 0° beams are produced at the same time (for the handover). This type of system is useful in tracking inclined-orbit NGSO satellites, where the consecutive satellite flight path is often shifted away from the previous one in the elevation plane (relative to a fixed location on earth surface). Thus, the standby beam can always be made ready at the incoming satellite direction, while the active beam is tracking. In this system, the beam tracking (in the azimuth plane) is accomplished by means of rotatory joint 4, and the beam adjustment (in the elevation plane) is carried out by actuator 5 which is mounted on the back of each haves of the reflector.

FIGS. 6(a), 6(b) and 6(c) show a variant of the beam-tracking antenna system shown in FIG. 1. In this alternative system, a single transceiver 6 is used, instead of two transceivers as shown in FIG. 1. The antenna system of FIG. 6 requires two RF rotary joints 4a and one RF switch 6d, which is disposed inside the transceiver unit 6. Beam scanning is handled by the RF rotary joint 4 and beam handover is accomplished by the RF switch 6d, twice in each scan cycle, in a similar way as the antenna system described in relation to FIG. 1.

FIGS. 7(a), 7(b) and 7(c) show a variant of the beam-tracking antenna system shown in FIG. 6. In this alternative system, a prime-focus parabola (instead of an offset parabola) is used in the formation of the torus reflector 1. This doubles the surface area of the antenna, which hence increases the antenna gain. There are some blockages from the feed system 3 and the boom support system 2 in this antenna system. The boom support system 2, feed system 3, rotary joint 4, linear actuator 5 and transceiver system 6 can be of the same type as the system shown in FIG. 1, or the system shown in FIG. 6.

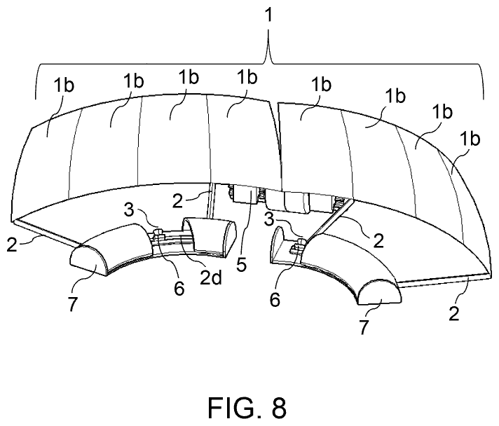

FIG. 8 shows an antenna system where the feed horns are moved on track-rails 2d instead of being rotated. This makes the antenna system more compact and reduces the boom length to support the feed systems. This arrangement includes a radome 7 covering the track-rail and the feed system.

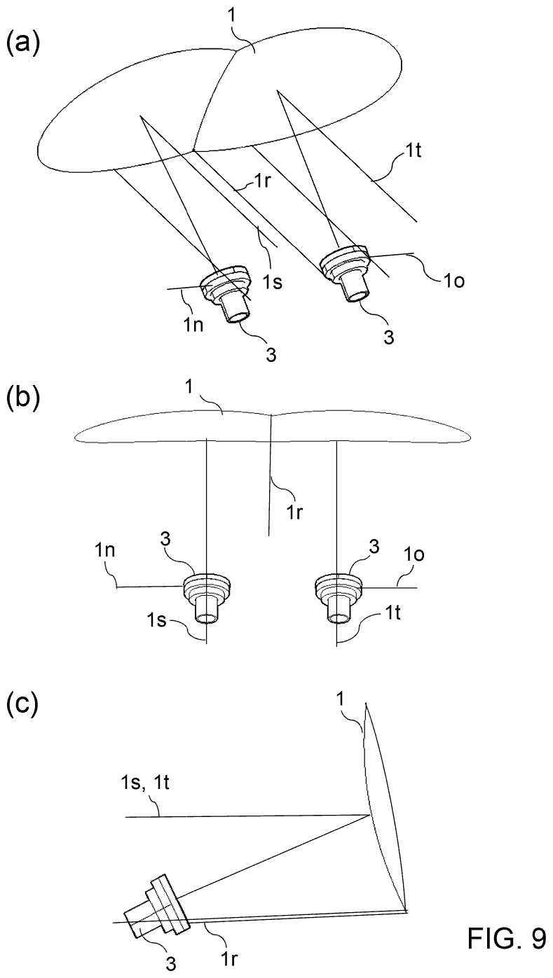

FIGS. 9(a), 9(b) and 9(c) show an arrangement where the reflector includes two offset parabolic reflector portions, rather than toroidal reflector portions. Details of the reflector 1, boom support system 2, feed system 3, rotary joint 4, linear actuator 5 and transceiver 6 are not shown in FIG. 9. These components can be of the same type either as the system shown in FIG. 1 (mechanical rotary joint 4d plus two transceivers 6), or the system shown in FIG. 6 (one transceiver 6 plus RF rotary joint 4a and switch 6d), or the system shown in FIG. 7 (prime-focus parabola). Equally, the arrangement of each reflector portion (one half of the entire reflector) sitting on a corresponding actuator, as shown in FIG. 5, may be applied to the present system too. Unlike the arrangements described above, the present system requires the feed to move linearly, in parallel to the antenna aperture plane, along feed tracks 1n and 10 to achieve the beam scanning. The scan beams deteriorate and the gain reduces with the increase of the scan angle.

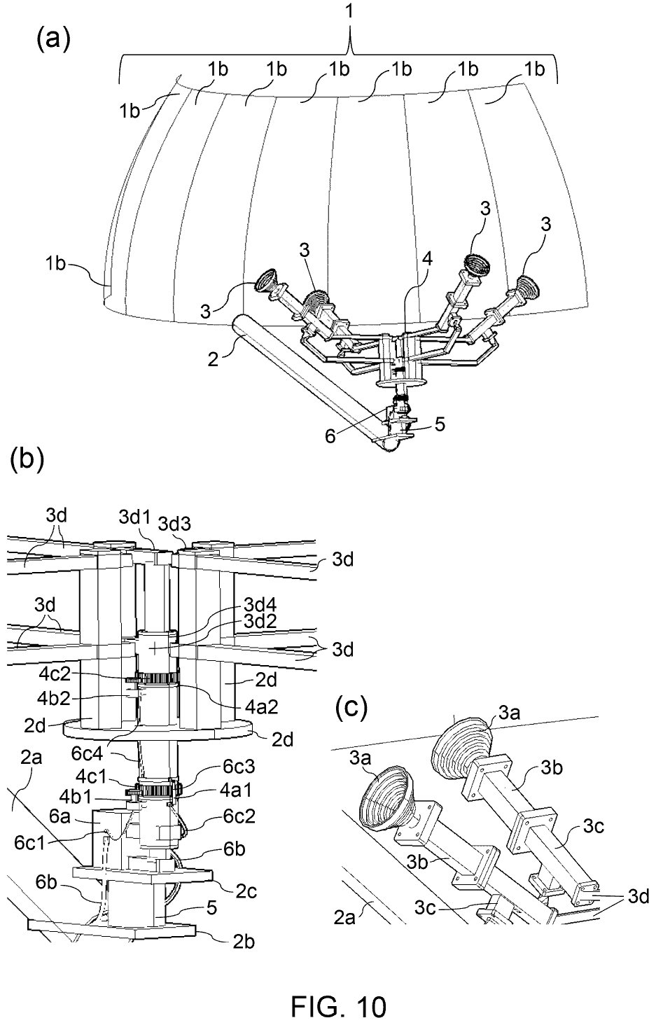

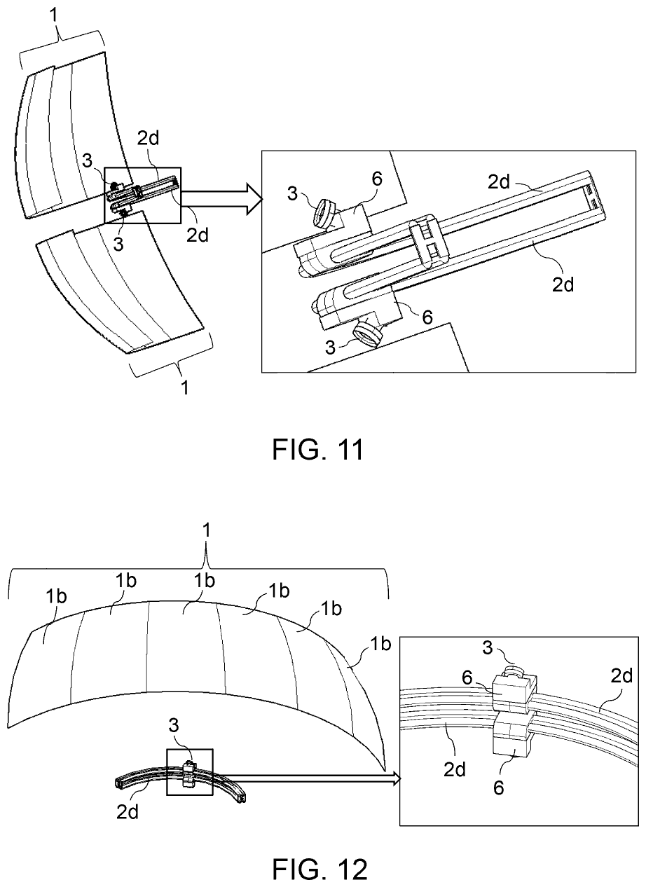

FIGS. 10(a), 11(b) and 11(c) shows an antenna system which uses a single toroidal reflector made up of multiple identical panels 1b. In this system, multiple feed systems 3 are used. With four sets of feed system 3 as shown in FIG. 10(a), as an example, a +/−45° scan range can be achieved (360° divided by four equally spaced feeds gives a 90° scan range for each feed). As another example, if a +/−60° scan range is required, six sets of feed systems 3 can be used.

To realise continuous beam-tracking or scanning and a seamless beam handover, the present system uses two RF rotary joints 4. One RF rotary joint 4 is used to drive the feed for the beam tracking and the other RF rotary joint 4 is used for the beam handover. FIG. 10(b) shows details of these two RF rotary joints—the lower rotary joint 4a1, 4b1 and 4c1 is used for the beam tracking and the upper rotary joint 4a2, 4b2 and 4c2, acting as an RF waveguide switch under control of a controller, is used for the beam handover.

Referring to FIGS. 10(a) and 10(b), the four feed systems 3 sit on a support plate and frame 2d. In the present example, the rotary joint 4a2 includes two output ports, one for the 30 GHz band (Tx) as 3d1 and the other for the 20 GHz band (Rx) as 3d2. In this case, the RF signal is electromagnetically coupled into, but physically disconnected, from the corresponding waveguide ports of the feed system 3d3 and 3d4. This allows the port to switch, by rotation from the rotary joint 4a2, to the respective feed system (one of the four feed systems in this case) as required during the beam handover in every −45° to +45° scan circle. The feed systems and the upper rotary joint 4a2 are supported by the lower rotary joint 4a1, which connects to RF transceiver 6, and all of these components are supported by the linear actuator 5.

The motor control wire 6c1 is connected to the lower rotary joint motor 4b1 directly. For the upper rotary joint motor 4b2, the control wire 6c2 connects to a brush/ring device 6c3 first then to the control wire 6c4. The brush/ring device 6c3 allows the connection of upper rotary joint motor 4b2 while lower rotary joint 4a1 is in rotation operation.

An example of the beam-tracking operation of the antenna system will now be described. A controller (not shown) controls the rotary joint 4a1 to run continuously to drive the feed 3a along the feed track, thus producing the tracking-beam to the user (e.g., the NGSO satellite). Beam handover occurs and is actioned by rotary joint 4a2 when the current feed reaches the end of the tracking range, and the next feed moves into the start point of the consecutive tracking cycle. This process repeats and each feed system comes into action in turn, thus establishing continuous beam-tracking.

FIG. 11 shows an antenna system in which two toroidal reflector portions are aligned vertically so that one reflector portion is above the other. The two feed systems are arranged in a similar manner. The mirrored arrangement of this antenna system produces two identical beams from the two separate feed horns at the same tracking angle. Unlike all the antenna systems described above, each feed system in this arrangement covers the entire beam-tracking range (e.g., from −45° to +45°), and the beam handover occurs once at each tracking cycle. While this allows the beam-tracking and hand-over to be carried out using just one antenna, this arrangement offers a ‘modem booster’ advantage where, in most time of the tracking cycle, both feed systems are actively tracking the same targets (e.g., an NGSO satellite) and the RF signals are thereafter combined in a modem to boost the signal strength or signal-to-noise ratio. The modem booster feature is not available around the beam handover time, where one feed system continues the tracking the other one must return to its start position and be ready for the handover to the incoming target (satellite). In the present example tracks 2d are used to move the feed. Equally the feed can be rotated to achieve the tracking beam. FIG. 12 shows an antenna system where a single feed system is used. Even though this will result in an outage of the telecom link momentarily as the feed needs time to return to pick up the incoming target (satellite), the simplicity and associated cost saving mean this arrangement is still useful for low data rate and low performance applications.

FIGS. 13(a) and 13(b) shows a beam-tracking antenna system where multiple feed systems are used to produce multiple beams simultaneously. For simplicity, only the torus reflector 1, feed horns 3a and transceiver 6 are shown in this drawing.

The feed horns 3a are arranged along the focus ring 1n and 10 and to face the torus reflector 1. In the present example, the feeds are arranged partially around a common axis. Other parts of the antenna, including the boom support system 2, feed system 3, rotary joint 4 and actuator 5 are the same, or similar to, the components used in the systems described above. Although only one transceiver is shown, in some examples multiple transceivers may be used. Each one of the transceivers may be connected to a respective feed or a group of feeds.

In this arrangement, using multiple and identical beams allows for three types of operations and applications:
Operation 1: multiple transceivers 6 are used, so that beam-tracking to multiple users or targets can be established simultaneously;
Operation 2: an RF switch 6d is employed, so that beam-tracking to a single moving user or target such as a NGSO satellite can be realised by beam switching; and
Operation 3: a beam-forming network 6e and/or algorithm is employed, then a shaped beam is produced which covers and matches the track of a moving target.

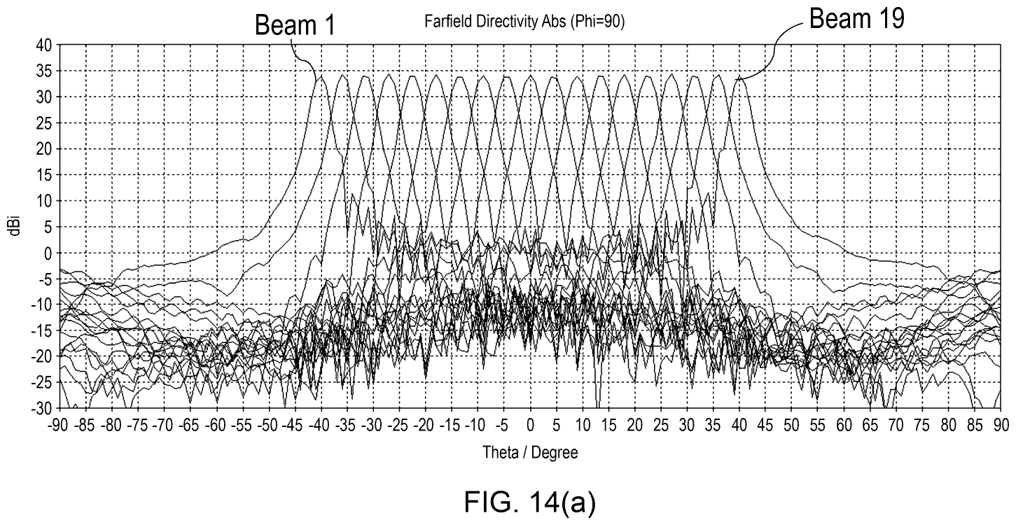

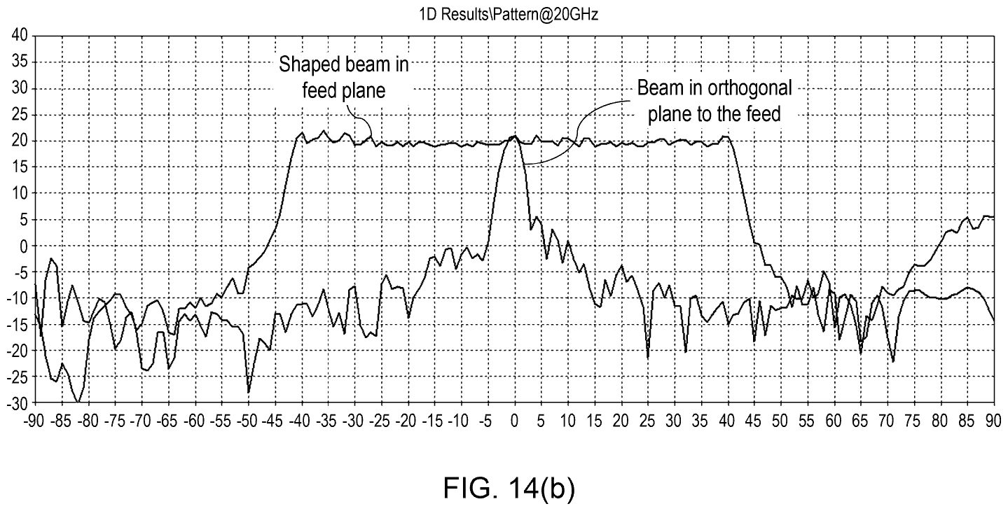

FIG. 14(a) shows a simulation result of 19 beams from the beam-tracking antenna system shown in FIG. 13. These beams cover a +/−40° scan range. When all the beams are combined, a shaped beam is produced (with an equal magnitude and phase in this case) as shown in FIG. 14(b). This shaped beam has a wide beamwidth in the feed horn plane (e.g., the flight path of a NGSO satellite) to cover a +/−40° range and a narrow beamwidth in the orthogonal plane (the elevation plane), which is compressed down by the reflector 1 to increase the antenna gain.

FIG. 15 shows the modular design of the torus reflector 1 shown in FIG. 1 in more detail. In this drawing, only three panels are shown: the central reflector panel 1a, and two side reflector panels 1b. The side panels 1b are the same on the left-hand and the right-hand side, and more panels can be used to extend the reflector 1 to cover a larger beam-tracking range.

All the panels are designed with a backing frame 1g to increase the mechanical rigidity of the reflector. Mounting bosses or features 1h are added to the central panel 1a, and these are used to support the antenna. Connections with the adjacent panels are made by alignment pins 1e, alignment sockets 1f and latches 1c and 1d.

This modular design provides a number of benefits and cost savings in tooling, manufacturing, packaging, transportation and logistics. The design allows rapid setup and assembly in the field. More importantly, the modular approach of the design makes it possible to dynamically alter the tracking range by adding or reducing the number of panels 1b included in the reflector 1. This makes the antenna system fully scalable in its dimensions and tracking range.

FIG. 16 shows a ring type reflector antenna system. The system includes a shaped toroidal reflector 1 and a feed system disposed inside the reflector. The feed system is arranged so as to face the reflector. In the present example, the system also includes a boom system 2, RF rotary joint and bearing 4, antenna base and mechanical support 5, RF transceiver system 6, radome 7, latches and alignment pins 8 and reflector antenna optics 9.

Apart from the reflector 1, the radome 7 and a part of the antenna base 5, the rest of the antenna system is conveniently concealed inside the ring reflector. The ring reflector also serves as a protective enclosure for the antenna. This arrangement greatly simplifies the antenna structure.

The entire reflector surface can be divided into multiple identical sub-panels during manufacturing, packaging and transportation. The full reflector can be securely and reliably assembled via latches and alignment pins 8.

The feed system 3, including the feed horn, and the RF transceivers 6 are supported by the boom system 2, which sits on an RF rotary joint or mechanical bearing 4. This allows the feed to freely rotate over 360°, and allows the antenna system to produce a 360° scan beam horizontally. The vertical beam direction 9 is defined by the feed position in front of the reflector. This is enabled by the motor and pulley in boom system 2. Depending on the operation frequency bands, the feed system can include a horn, patch or slot type antenna. The feed system also includes the feeding waveguides, feeding microstrip lines, coaxial cables, polarizers, RF filters and orthogonal mode transceivers (OMT) etc.

The entire antenna rests on a flat base 5 and is covered by a radome 7 at its top.

An example of the beam-tracking operation of the antenna system will now be described.

In the location shown in FIG. 16, the feed horn produces an antenna beam in the vertical plane at 27° from the antenna boresight. The beam direction in the vertical plane changes with the feed (horn) location, which is set by moving the feed horn up or down. In the horizontal plane, the entire RF chain including the feed system 3 and RF transceiver system 6 rotates around the antenna axis, thus producing a 360° scan beam continuously for whatever the vertical beam direction is. This ensures continuous, uninterrupted beam-tracking or scanning within a conical space in front of the antenna.

As shown in FIG. 16, the ring reflector 1 is constructed from multiple identical panels. These panels are linked and assembled together with the use of alignment pin 8c and latches 8a and 8b. This modular design approach has the advantages of reducing tooling and manufacturing costs, reducing the package volume, transportation and logistics costs and is scalable in the product offering, e.g., increasing or reducing antenna size and beam-scan range in the horizontal plane by adding or reducing the number of panels (not all applications require 360° beam scanning).

The reflector surface can be made of, for example, pressed sheet-metal, moulded plastic with surface metallisation or carbon-composite.

The function of the boom system is to:
Provide mechanical support to the RF transceiver system 6 and feed system 3;
Set the feed horn 3 in the correct position and orientation towards the ring reflector 1; and
Carry the RF coaxial cables 6b and electrical control wires 6c to and from the transceiver 6a, and the rotary joint 4

As an example, the boom system 2 includes a boom base 2a, boom rack 2b, rail track 2c, actuator plate 2d, transceiver plate 2e, pulley and gear 2f, motor and gear 2g and linear actuator 2h. The boom rack 2b and rail track 2c are set at an angle which ensures that the feed 3 moves along the focal plane of the parabola vertically. The movement of the feed 3 is carried out by the pulley and gear 2f, which is driven by the motor and gear 2g.

To ensure the feed (horn) points to the ring reflector centre (to maximise the RF field illumination on to the ring reflector and minimise the spill-over loss), a linear actuator 2h is used.

The RF transceiver 6a is connected to the feed system 3 directly. This reduces the RF loss. The boom base 2a sits onto RF rotary joint 4, which allows continuous rotation horizontally.

Due to the toroidal nature of the ring reflector, the antenna beam in the horizontal plane is consistent regardless of the scan angle.

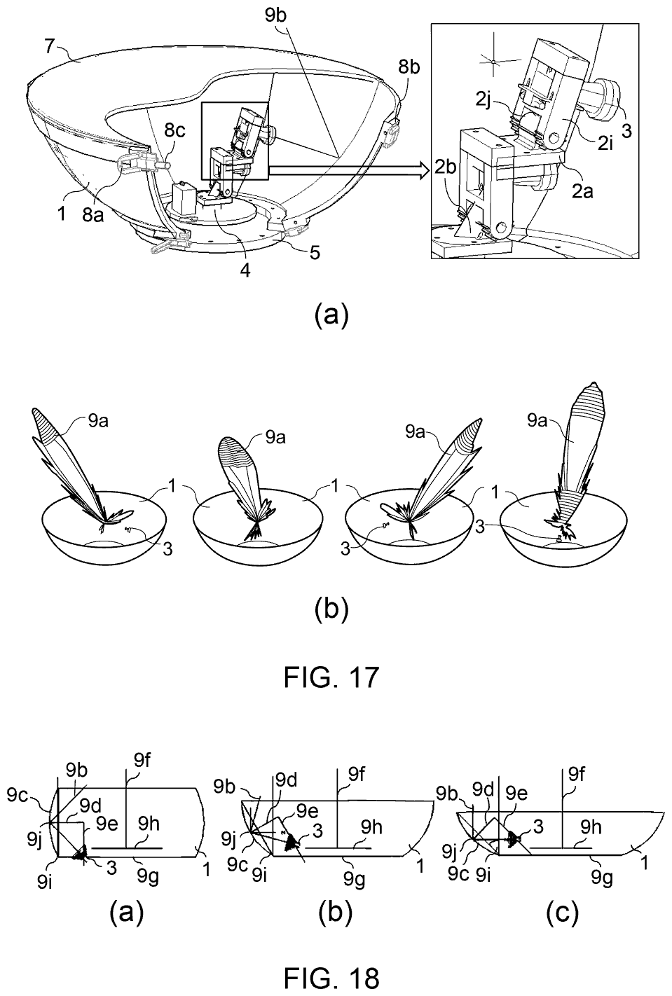

FIG. 17(b) illustrates the consistent scan beams from the ring type reflector antenna shown in FIG. 16. For many applications where a continuous and dynamic vertical beam scan is not necessary, then the boom system can be simpler. FIG. 17(a) shows an example where an adjustable vertical beam direction can be easily made via the use of mounting bracket 2i onto boom rack 2b. There is a predefined feed (horn) marker 2j on mounting bracket 2i for the correct setting of the horn 3 orientation and beam direction 9b.

FIG. 18 shows an example of the ring type reflector shape, and the antenna beam direction in the vertical plane, which can be changed by tilting the parabolic generating curve with an angle 9i. FIG. 18(a) is a perfect ring type reflector where the tilting angle is 0°, while a dish-like reflector is formed when the tilting angle is 45° in FIG. 18(c). Note, with a larger tilting angle 9i the reflector 1 becomes flatter and the ring is bigger. At the same time the beam direction 9b is changed when the feed (horn) 3 location is kept the same relative to the focal length and point 9d.

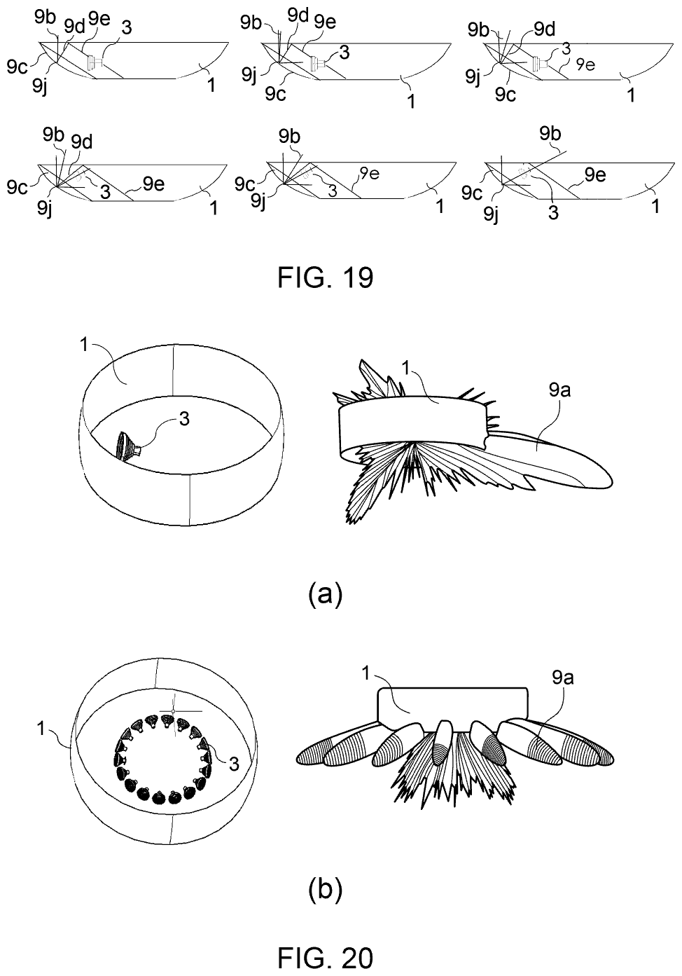

FIGS. 19(a) to 19(f) show examples of a beam scan in the vertical plane. As an example, for a 45° tilting angle in ring reflector 1, the feed (horn) 3 is moved along the focus plane 9e. This creates a vertical beam scan which can be seen from the different beam direction 9b in FIGS. 19(a) to 19(f). This vertical beam scan is enabled by the boom system 2 as displayed in FIG. 16.

FIGS. 20(a) to 20(b) illustrate the use of a ring reflector for a beam scan towards the ground. The beam 9a is down-tilted to cover a certain area of the ground, and its down-tilting angle can be pre-set discretely by the feed (horn) position using mounting bracket 2i shown in FIG. 17(a), or dynamically via the motor 2g and pulley 2f as described in FIG. 16. This antenna has many applications. One of them is for the fixed wireless access in the 5G or 6G network.

FIGS. 20(c) to 20(d) also illustrate the use of multiple feeds (horns) 3 to produce multiple beams 9a simultaneously. The feeds 3 are arranged so as to face the reflector 1. A controller (not shown) may control RF switches (not shown) connected to the feeds so as to selectively activate a particular feed to illuminate a particular region of the reflector. Together with the use of multiple transceivers, this antenna can serve multiple users at the same time, without losing RF performance. The beam direction 9a can be set by the feed (horn) location inside the ring, both vertically and horizontally.

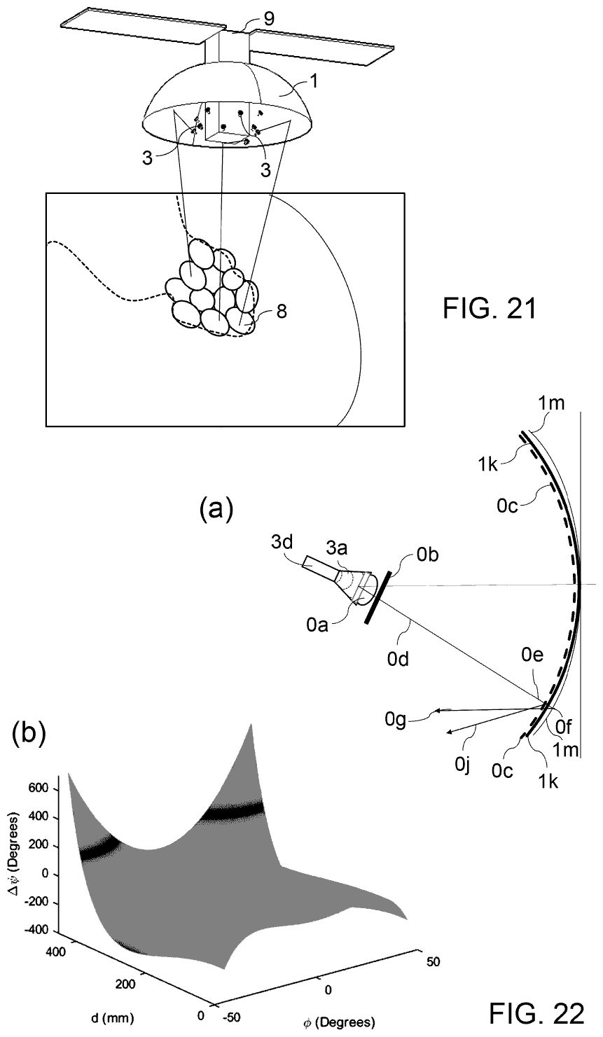

FIG. 21 shows an example of a satellite including an antenna system with a ring-type toroidal reflector. This illustrates the application of a ring-type toroidal reflector antenna system for the generation of multiple spot beams in high throughput satellites (HTS), either in NGSO or geostationary orbit. The current solution for generating multiple spot beams is to use multiple parabolic reflectors with multiple feed horns. According to the present example, the multiple reflectors can be replaced by a single ring-type toroidal reflector 1, particularly when the ring type reflector can be of the deployable nature, by wrapping the reflector 1 around the body of the satellite 9 conveniently. The multiple feed horns 3 are disposed on the body of the satellite 9 with defined positions, relative to the ring type reflector 1, to generate the multiple spot beams 8 on the Earth's surface as required.

FIGS. 22(a) and 22(b) illustrate a method of addressing phase aberration in a toroidal reflector. Referring to FIG. 22(a) in the beam-tracking plane, the toroidal reflector surface follows a circular track 1k rather than a parabolic track 1m, hence there exists a certain degree of phase aberration due to the difference between the torus surface 1 and the equivalent parabola surface 1m. Taking an incident RF wave 0d as an example in FIG. 22(a), the wave reflection points from the torus surface 1 and the equivalent parabolic surface 1m are 0e and 0f respectively, thus the reflected beam is in the direction 0j rather than 0g. Phase aberration in the toroidal reflector reduces the antenna gain and efficiency.

FIG. 22(a) illustrates a number of measures which can be included in an antenna system to alleviate or correct the phase aberration. These correction measures can be applied to any of the toroidal reflectors described herein. The correction measures include the use of a lens 0a disposed inside or in front of the feed horn 3a; a transmit-array 0b based on RF meta-material technology and placed in front of the feed horn 3a; and a reflect-array 0c or frequency selective surface (FSS) applied onto the torus surface 1. The meta-material of the transmit-array reacts to the RF signal to create an RF phase shift which is used to compensate for the toroidal surface phase error. The reflect-array uses a meta-surface, which works in a similar way to the meta-material. The purpose of these correction measures is to pre-set the phase differences accordingly so when the RF wave is reflected from the torus surface the phase aberration is offset or cancelled. Applying one or more of these measures allows for the use of reflectors with relatively small radii of curvature, which are more compact.

FIG. 22(b) provides an example of the phase aberration in a 450 mm height and 300 mm focal length torus reflector, where one can see the largest phase errors are towards the top-edge section of the feed horn illumination on the torus reflector surface. These are the regions the correction measures focus on.

Various further modifications to the above described examples, whether by way of addition, deletion or substitution, will be apparent to the skilled person to provide additional examples, any and all of which are intended to be encompassed by the appended claims. It should be noted that the description and drawings should be interpreted in an illustrative, rather than a limiting, sense.

The following passages set out examples of possible combinations of features.
A1) In a first aspect, an antenna system is provided that comprises a ring reflector, wherein all the RF and mechanical systems including the feed (horn), transceiver, boom and rotary joint are kept inside the ring reflector.
A2) An antenna system as set out in A1), wherein the reflector surface serves also as a protection enclosure for the antenna.
A3) An antenna system as set out in A1) or A2), that produces a 360° continuous beam scan with constant antenna beam and gain.
A4) An antenna system as set out in any one of A1) to A3), that also produces a scan beam in the plane orthogonal to the 360° beam scan plane.
A5) An antenna system as set out in any one of A1) to A4), that has means of pre-set the beam direction both horizontally and vertically.
A6) An antenna system as set out in any one of A1) to A5), that has multiple feeds (horns) or radios/transceivers, thus producing multiple antenna beams for simultaneous communication with multiple users.
A7). An antenna system as set out in any one of A1) to A6), that has multiple feeds (horns) and RF switches, thus one radio/transceiver can serve multiple users at different locations by feed (horn) and beam switching.
A8) An antenna system as set out in any one of A1) to A7), that produces scan or track beam(s) without the need to rotate the entire antenna system.
A9) An antenna system as set out in any one of A1) to A8), whose reflector comprises multiple identical panels, to reduce the cost in tooling, manufacturing, packaging and transportation.
B1) In a second aspect, an antenna system is provided that is based on single, joined and shaped reflectors with one or multiple feeds, offering a single beam, multiple beam(s) or shaped beam(s) for radio links which track a moving user or target, or scan a number of users or targets, by moving or rotating the feed or selecting the feed which is positioned across the reflector aperture.
B2) An antenna system as set out in B1), wherein the reflector is formed by joining two individual reflectors, thus a common beam is produced by each of the reflectors near the joint line, and this allows a beam-tracking or scanning handover from one side of the reflector to another at or near the joint line.
B3) An antenna system as set out in B1) or B2), wherein the antenna beam is handed over at the end of tracking or scanning from one side of the reflector to another. Together with the handover at or near the joint line of the reflector, which is typically at the center of the reflector, this allows the antenna system to track and scan the users or targets continuously without interruption.
B4) An antenna system as set out in any one of B1) to B3), wherein the reflector is a toroidal type which is formed by rotating a parabola curve around a circle, thus providing constant antenna beams at all scan angles.
B5) An antenna system as set out in any one of B1) to B4), wherein the reflector is of a parabolic type or other shaped types.
B6) An antenna system as set out in any one of B1) to B5), wherein the reflector is of either a prime-focus or offset type.
B7) An antenna system as set out in any one of B1) to B6), wherein one or more phase compensation measures are employed to alleviate or correct the phase aberration on the reflector surface. The measures include, but are not limited to, the use of lens(es) inside or in front of the feed, a transmit array in front of the feed, an reflect array on or in front of the reflector surface. These measures may be meta-material based, frequency selected surface (FSS) based, or printed circuit board (PCB) based.
B8) An antenna system as set out in any one of B1) to B7), wherein one single radio frequency (RF) transceiver is used in tandem with RF switches or an antenna beam-forming network and algorithm for beam-tracking, scanning or switching.
B9) An antenna system as set out in any one of B1) to B8), wherein two or multiple RF transceivers are employed to offer either tracked beams or switched beams or multiple beams simultaneously.
B10) An antenna system as set out in any one of B1) to B9), wherein the reflector is designed and manufactured in a modular approach, to reduce cost in tooling, manufacturing, packaging, transportation and logistics. Further, the approach allows the antenna system to scale up or down in size and beam-scan ranges by adding or removing identical panels. The design also allows a quick and reliable assembly in field by the alignment pins and latches.
B11) An antenna system as set out in any one of B1) to B10), wherein two RF rotary joints are employed. One of the RF rotary joints serves as a RF switch which activates only when the antenna beam handover is required, and the other rotary joint drives the feed by rotation for antenna beam scan.

1. An antenna system comprising:
a reflector comprising a first reflector portion having a curved shape defined with respect to a first reference point, and a second reflector portion having a curved shape defined with respect to a second reference point, the second reference point being different from the first reference point;
a first feed arranged to illuminate the first reflector portion with a first beam;
a second feed arranged to illuminate the second reflector portion with a second beam;
one or more first actuators arranged to move the first feed;
one or more second actuators arranged to move the second feed; and
a controller configured to control the first actuator and the second actuator to move the first feed and the second feed so as to continuously track a moving target or continuously scan a number of targets.

2. An antenna system according to claim 1, wherein the controller is configured to:
control the first actuator to move the first feed from a first start position to a first end position so as to scan the first beam across the first reflector portion; and
control the second actuator to move the second feed from a second start position to a second end position so as to scan the second beam across the second reflector portion.

3. An antenna system according to claim 2, wherein the controller is configured to:
control the first actuator to move the first feed from the first end position back to the first start position while the second feed is moving from the second start position to the second end position.

4. An antenna system according to claim 2 or 3, wherein the controller is configured to:
control the second actuator to move the second feed from the second end position to the second start position while the first feed is moving from the first start position to the first end position.

5. An antenna system according to any one of claims 2 to 4, wherein when the first feed is at the first end position and the second feed is at the second start position, the first beam and the second beam are substantially coincident on the reflector.

6. An antenna system according to any one of the preceding claims, wherein the first reflector portion and the second reflector portion are joined together at a joint line; and
wherein the first and second reflector portions and the first and second feeds are arranged such that, in use, a common beam is produced by each of the first and second reflector portions and the first and second feeds at the joint line, thereby allowing a beam handover from the first reflector portion to the second reflector portion at or near the joint line.

7. An antenna system according to any one of the preceding claims, wherein the one or more first actuators comprise a first actuator arranged to adjust the azimuth of the first beam and the one or more second actuators comprise a second actuator arranged to adjust the azimuth of the second beam.

8. An antenna system according to any one of the preceding claims, wherein the one or more first actuators comprise a first actuator arranged to adjust the elevation of the first beam and the one or more second actuators comprise a second actuator arranged to adjust the elevation of the second beam.

9. An antenna system according to any one of claims 1 to 8, further comprising a support mast arranged to support the first reflector portion and the second reflector portion.

10. An antenna system according to any one of claims 1 to 8, further comprising a first support mast arranged to support the first reflector portion and a second support mast arranged to support the second reflector portion.

11. An antenna system according to any one of the preceding claims, further comprising: a first reflector portion actuator arranged to adjust the elevation of the first reflector portion to thereby adjust the elevation of the first beam and/or a second reflector portion actuator arranged to adjust the elevation of the second reflector portion to thereby adjust the elevation of the second beam.

12. An antenna system according to any one of claims 1 to 11, wherein the first reference point represents the centre of a first imaginary torus and the first reflector portion has a shape corresponding to a section of the first imaginary torus, and wherein the second reference point represents the centre of a second imaginary torus and the second reflector portion has a shape corresponding to a section of the second imaginary torus.

13. An antenna system according to any one of claims 1 to 11, wherein the first reference point represents the focus of a first imaginary paraboloid and the first reflector portion has a shape corresponding to a section of the first imaginary paraboloid, and wherein the second reference point represents the focus of a second imaginary paraboloid and the second reflector portion has a shape corresponding to a section of the second imaginary paraboloid.

14. An antenna system according to any one of the preceding claims, wherein the reflector is a prime-focus type reflector or an offset type reflector.

15. An antenna system according to any one of claims 1 to 14, comprising an RF transceiver connected to the first feed and the second feed.

16. An antenna system according to any one of claims 1 to 14, comprising a first RF transceiver connected to the first feed and a second RF transceiver connected to the second feed.

17. An antenna system according to any one of the preceding claims, wherein the first reflector portion and the second reflector portion each comprise a plurality of panels.

18. An antenna system according to any one of the preceding claims, wherein the shape of the second reflector portion is a mirror reflection of the shape of the first reflector portion.

19. An antenna system according to any one of the preceding claims, further comprising one or more correction measures arranged to correct phase aberration in the reflector.

20. An antenna system according to claim 19, wherein the one or more correction measures comprise one or more of the following:
a lens disposed inside or in front of the first feed and/or the second feed;
a transmit-array disposed in front of the feed, wherein the transmit-array is based on RF meta-material technology; and
a reflect-array disposed on the torus surface, wherein the reflect-array comprises a meta-surface.

21. An antenna system comprising:
a toroidal reflector;
a plurality of feeds arranged to illuminate the reflector, the feeds being arranged around a common axis;
a motor configured to generate a rotary force to rotate the feeds about the axis; and
a first controller configured to control the motors to rotate the feeds about the axis so as to continuously track a moving target or continuously scan a number of targets.

22. An antenna system according to claim 21, further comprising:
a second controller; and
an RF switch connected to the feeds,
wherein the second controller is configured to activate the RF switch when an antenna beam handover from one of the feeds to another one of the feeds is required.

23. An antenna system according to claim 21 or 22, further comprising:
an RF transceiver; and
an RF rotary joint arranged to transfer an RF signal from the RF transceiver to the feeds or vice versa.

24. An antenna system comprising:
a toroidal reflector; and
a plurality of feeds facing the reflector and arranged to illuminate the reflector simultaneously.

25. An antenna system according to claim 24, further comprising:
one or more RF transceivers connected to the feeds.

26. An antenna system according to claim 25, wherein each of the RF transceivers is connected to a respective feed or a group of feeds, and
wherein the RF transceivers are arranged to control the feeds to provide tracked beams or switched beams, or multiple beams simultaneously.

27. An antenna system according to any one of claims 24 to 26, further comprising a plurality of RF switches connected to the feeds, wherein the RF switches are arranged to perform beam-switching by selecting different feeds.

28. An antenna system according to any one of claims 24 to 27, further comprising an antenna beam-forming network configured to combine one or more of the feeds together to form a shaped beam.

29. An antenna system according to any one of claims 24 to 28, further comprising:
a computer-readable medium storing a beam-forming algorithm for beam-tracking using the feeds.

30. An antenna system according to any one of claims 24 to 29, wherein the feeds are arranged at least partially around a common axis.

31. An antenna system comprising:
a ring-shaped toroidal reflector; and
a moveable feed disposed inside the reflector, the feed being arranged to illuminate the reflector with a beam.

32. An antenna system according to claim 31, further comprising a first motor disposed inside the reflector, wherein the first motor is arranged to rotate the feed around the central axis of the reflector so as to scan the beam around the entire reflector.

33. An antenna system according to claim 31 or 32, further comprising a boom system disposed inside the reflector and arranged to support the feed, wherein the boom system comprises a second motor arranged to adjust the elevation of the feed to thereby adjust the elevation of the beam.

34. An antenna system according to any one of claims 31 to 33, further comprising a transceiver disposed inside the reflector and connected to the feed.

35. An antenna system comprising:
a ring-shaped toroidal reflector; and
a plurality of feeds disposed inside the reflector, each of the feeds being arranged to face the reflector and illuminate the reflector with a respective beam.

36. An antenna system according to claim 35, further comprising:
a plurality of RF switches connected to the feeds; and
a controller configured to control the RF switches so as to selectively activate a particular feed to illuminate a particular region of the reflector.

37. A satellite comprising:
a body; and
an antenna system according to claim 35 or 36,
wherein part of the body is disposed inside the reflector, and the feeds of the antenna system are disposed on the outside of the body to produce multiple spot beams on the Earth's surface in use.

38. A satellite according to claim 37, wherein the satellite is a high throughput satellite.
